(19) United States
(12) Patent Application Publication
(10) Pub. No.: US 2008/0118633 A1
(43) Pub. Date: May 22, 2008

(54) Methods for creating electronic circuitry comprising phenolic epoxy binder compositions

(76) Inventors: Cheng-Chung Chen, Raleigh, NC (US); Thomas Eugene Dueber, Wilmington, DE (US); Shane Fang, Newark, DE (US); John D. Summers, Chapel Hill, NC (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/982,766

(22) Filed: Nov. 5, 2007

Related U.S. Application Data
(60) Provisional application No. 60/860,263, filed on Nov. 21, 2006.

(51) Int. Cl. B05D 5/12

(52) U.S. Cl. 427/101

(57) ABSTRACT

The invention relates generally to methods for creating circuitry components from binder materials having a hydrophobic phenolic component and a hydrophobic epoxy component. The phenolic/epoxy based liquids, solutions, suspensions and/or pastes can generally be screen printed or otherwise formed on an electronic substrate, pattern or device, to provide an electronic component having low water sorption properties.

### FIELD OF INVENTION

The present invention relates generally to dielectric compositions for electronic circuitry applications. More specifically, dielectrics of the present invention provide advantageously consistent properties, due at least in part to the presence of phenolic epoxy moieties.

### BACKGROUND OF THE INVENTION

U.S. Pat. No. 5,980,785 to Xi, et al. broadly teaches compositions useful in electronic applications created by screen-printing pastes, followed by heat and/or chemical reaction induced solidification. However as the electronics industry advances, many such pastes must be increasingly resistant to water sorption in high humidity, high temperature environments. A need also exists for resistor type compositions having low moisture uptake, while also capable of direct application to copper traces or the like.

### SUMMARY OF THE INVENTION

The present invention is to a method of manufacturing polymeric thick film resistor compositions, including touch screens, circuit boards, semiconductor device packaging and the like, for electronic circuitry applications. Methods of the invention include the combining a plurality of filler particles into a binder. The binder contains a cyclo-aliphatic moiety, a phenolic moiety and an epoxy moiety. The binder is contacted with a substrate and cured. The cured substrate is a polymeric thick film resistor having: i. a glass transition temperature (“Tg”) of at least 200 (° C.); ii. a moisture content of less than 1 weight percent; and iii. a thermal coefficient of resistance less than 200 ppm/° C.

### DETAILED DESCRIPTION OF THE PREFERRED EMBODIMENTS

In one embodiment of the present invention, the binder comprises a hydrophobic phenolic moiety and a hydrophobic epoxy moiety, whereby binder component is ultimately cured to a composition exhibiting:
1. a high degree of cross-linking, i.e., a glass transition temperature (“Tg”) of at least 200, 225, 250, 275, 300, 325, 350, 375, 400, 425, 450, 500, 525, or 550 (° C.); and
2. low moisture sorption properties, i.e., less than 1, 0.5, 0.2, 0.1, 0.05, 0.02, 0.01, 0.005 or 0.001 percent increase in weight after a 24 hour HAST test at 2 atmospheres, 85% relative humidity and 85° C.

In one embodiment, the binder composition contains a phenolic epoxy resin comprising a dicyclopentadiene moiety. In one embodiment, the epoxy resin is a dihydroxynaphthalene diglycidyl ether (e.g., dicyclopentadience-modified cresol novolac resin) and/or a naphthol-modified cresol novolac epoxy resin. The rigid naphthalene moiety can make the epoxy backbone more rigid and moisture resistant. In an alternative embodiment, the opoxy comprises an alicyclic ring on its backbone, such as limonene phenol novolac epoxy.

Water sorbtion can cause undesirable expansion or swelling, which is sometimes defined according to a material's “coefficient of hydroscopic expansion.” In one embodiment of the present invention, the final cured binder material exhibits a coefficient of hydroscopic expansion of less than 10,000, 8000, 5000, 2500, 1000, 500, 250, 200, 150, or 100 parts per million per degree Centigrade.

A potential consequence of undue moisture swelling or expansion is that the average distance between conductive fillers in the matrix can vary in proportion to the amount of moisture sorption, thereby causing unwanted variability in resistance properties due to corresponding variability in moisture sorption. In one embodiment of the present invention, the resistance variability is less than 0.1, 0.2, 0.5, 0.75, 1, 2, 5, 7, 10, 12, 15, 18, 20, 22, or 25 percent.

Moisture can also be detrimental if it penetrates into the interface between a copper conductor trace and a printed resistor, particularly if the moisture is able to diminish bond integrity (e.g., by greater than 1, 3, 5, 7, 10, 12, 15, 20, or 25 percent) between the metal and the resistor material. Moisture can also contribute to undesirable copper oxidation at the copper interface, particularly if moisture causes a thin oxide layer between the resistor and the copper trace.

A number of known tests are useful in measuring water sorption. One test involves weighing a material, then placing it in an 85° C., 85% relative humidity environment for a number of hours or days, and thereafter weighing the sample to determine the amount of water sorption (“85/85 test”). Alternatively or in addition, water sorption can be measured using a highly accelerated stress tester (“HAST”) which is similar to the 85/85 test described above, but the environment is further modified by increasing pressure (such as, from 1 atmosphere to 2), using a pressurized vessel.

In one embodiment, polymer thick film resistors are prepared from hydrophobic epoxy-containing and hydrophobic phenolic-containing resins. Useful resins include but are not limited to those containing elevated levels of hydrocarbon character (e.g., at least 80, 90, 91, 92, 93, 94, 95, 96, 97, 98, 99, 99.5, or 99.8 mole percent hydrocarbon) through hydrocarbon-rich groups, such as, alicyclic or aliphatic moieties of at least 4, 5, 6, 7, 8, 9, 10, 11, 12, 15, or 20 carbon atoms, e.g., cyclohexane, bicyclics, or long, straight chain hydrocarbons. In a further non-limiting embodiment, useful resins may contain fluorine or a fluorine base moiety.

The resistive materials of the present invention exhibit advantageously low moisture sorption and also tend to exhibit an advantageous ability to make reliable bonds with micro-etched copper, e.g., a bond peel strength of greater than 1, 2, 3, 4, 5, 10, 20, 25, 30, 35, 50, 75, 100, 200, 500, 700 or 1000 dynes of force per centimeter of delamination. Notably, immersion silver terminations (to achieve resistor reliability, especially in 85/85 testing) is generally not required.

### Phenolics

As used herein, phenolics, phenolic polymer, and phenolic resin are intended to have the same meaning (i.e., compositions comprising a phenol moiety, whether a monomer, oligomer, pre-polymer, polymer or combinations thereof), and are used interchangeably. Phenolics useful in the present invention include, but are not limited to:
1. Durite D_SD-1819™ and Durite D_SD-1829™ (phenol-dicycolpentadiene adducts) from Hexion Specialty Chemicals, Inc. (Columbus, Ohio, USA);
2. Durite E_SD-1817™ (high-nitrogen content high-purity phenol-formaldehyde novolac) from Hexion Specialty Chemicals, Inc. (Columbus, Ohio, USA);
3. Durite SD-1708™ (high-purity phenol-formaldehyde novolac) from Hexion Specialty Chemicals, Inc. (Columbus, Ohio, USA);
4. Durite SD-1502™ (bisphenolA-formaldehyde novolac curative for epoxy resins) from Hexion Specialty Chemicals, Inc. (Columbus, Ohio, USA);
5. DPR-5000™ (dicyclopentadiene-modified cresol novolac resin), from Mitui Toatsu Kagaku;
6. YLK-402™ (limonen phenol novolac resin), from Yuka-Shell; PSM-4261 (Phenol novolac resin), from Gunei Kagaku Kogyo K. K.;
7. GP 5833™ (phenolic novolac) from Georgia Pacific, Atlanta, Ga., USA;
8. TD-2093 (meta-cresol phenolic resin) from Dainippon Ink & Chemical Co. Tokyo, Japan;
9. TD-2090™, (meta-cresol phenolic resin) Dainippon Ink & Chemical Co. Tokyo, Japan;
10. MEH-7500™ (a multifunctional phenolic resin) from Meiwa Plastic Industries, Ltd., Ube Japan;
11. DPP-M™ (a dicyclopentadiene phenolic resins) from Nippon Kasei Chemical Company, Limited. Tokyo Japan;
12. DPP-L™ (a dicyclopentadiene phenolic resins) from Nippon Kasei Chemical Company, Limited. Tokyo Japan,
13. Useful phenolics also include hydrophobic bisphenols, such as tetrabromobisphenol-A, tetramethylbisphenol-A, hexafluorobisphenol-A, and the like.

In some paste type applications, it may be useful to choose a phenolic with a number average molecular weight of less than any of the following (or alternatively, between and including any two of the following): 100,000; 50,000; 25,000; 20,000; 15,000; 10,000; 5000, 4000, 3000, 2500, 2000, 1500, 1200, 1000, 800, 600, 500, 400, 300, or 250.

### Epoxies

Epoxies useful in the present invention include, but are not limited to:
1. From Hexion Specialty Chemicals, Inc. (Columbus, Ohio, USA):
   a. EPON Su-8™ and Su-3 ™, epoxy novolac;
   b. Epikote 154™: phenol based epoxy novolac;
   c. Epikote 157™: bisphenol A based epoxy novolac;
   d. EPON 164™: ortho-cresol based epoxy novolac;
   e. EPON 1050™: bisphenol A based epoxy;
   f. EPON 828™: bisphenol A based epoxy;
   g. EPON 1001™: bisphenol A based epoxy;
   h. EPON 862™: bisphenol F based epoxy;
   i. RSS-1407™: tetramethylbiphenol epoxy; and
   j. EPON 165™: epoxy cresol novolac resin.
2. From Nippon Kagaku:
   a. phenolic polymer with 3a,4,7,7a-tetrahydro-4,7-methano-1H-indene, glycidyl ether,
   b. ortho-cresol novolac epoxy resin (EOCN-1020™);
   c. poly(glycidyl ether) of phenol-2-hydroxybenzaldehyde novolac (EPPN-502H™);
   d. naphthol-modified cresol novolac epoxy resin, (EOCN-7000™);
3. From Dai Nippon Chemical:
   a. dicyclopentadience epoxy resin (DCPD EPICLONE HP 7200 L™);
   b. tetrabromobisphenol A epoxy resin (DIC 153™);
   c. tetrabromobisphenol A epoxy resin (DIC 152™);
4. From Dow Chemical: bisphenol A based epoxy (DER 331 ™);
5. From Shin'Nittetu Kagaku: 9′9′-Bis(4-hydroxyphenyl)fluorine diglycidyl ether (ESF-300™);
6. From Yuka-Shell Epoxy KK:
   a. tetramethyl biphenyl diglycidyl ether (YX-4000H™);
   b. tetrakis(4-hydroxyphenyl)ethane (E-1031S™);
   c. limonen phenol novolac epoxy resin (YL-6241™);
7. From Dainihon Inki Kogyo Co.:
   a. 4,4′oxybis(1,4-phenyl ethyl)tetra-cresol glycidyl ether (EXA-610™);
   b. 4,4′oxybis(1,4-phenyl ethyl)phenyl glycidyl ether (EXA-700™);
   c. bis(dihyroxynaphthalene)tetra-glycidyl ether (EXA-4700™);
   d. dihydroxynaphthalene diglycidyl ether (HP-4032H™);
   e. alkyl phenol-modified phenol novolac epoxy (EXA-4506™);
   f. Dihyroxynaphthyl cresol triglycidyl ether (EXA-4300™);
   g. xylene-modified phenol novolac epoxy resin (EXA-1857T™);
   h. triglycidyl ether of dinaphthyl triol (EXA-4750™);
8. From Nan Ya Plastics Corp.:
   a. cresol novolac epoxy resin (NPCN-703™);
   b. cresol novolac epoxy resin (NPCN-604™);
   c. novolac epoxy resin (NPCN-638™); and
9. From Daicel Chemical Industries, Ltd:
   a. condensation products of 1-2-epoxy-4(2-oxiranyl)-cyclohexane, 2,2-bis(hydroxyl methyl) 1-butanol and (3′4′-epoxycyclohexane) methyl 3,4-epoxycyclohexyl-carboxylate mixture (EHPE-3150CE™); and
   b. condensation products of 1-2-epoxy-4(2-oxiranyl)-Cyclohexane and 2,2-bis(hydroxyl methyl) 1-butanol (EHPE 3150™).

The chemical structure of dicyclopentadiene (DCPD) type epoxy resin is:

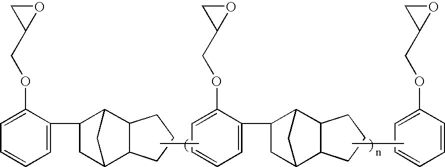

and can be a useful epoxy resin in accordance with the present invention.

A further embodiment of the invention relates to compositions comprising phenolics described herein and low moisture absorption epoxidized polycyclic norbornene materials (“PNBs”), such as from Promerus Electronic Materials, under the tradename Avatrel 2390 ™.

In a further embodiment of the invention, partially epoxidized phenolic resin, which are self-crosslinking and hydrophobic are utilized.

### Catalysts

In an aspect of the invention, the polymer binder further includes an epoxy/phenol reaction catalyst. Catalysts useful in the present invention include, but are not limited to amines and blocked amines, such as, benzyldimethyl ammonium acetate; benzyltrimethylammonium chloride; benzyldimethyl ammonium hydroxide; betaine; benzyldimethyl amine; dicyandiamide; 2-ethyl-4-methyl imidazole; hexamethylenetetramine; and the like.

### Pastes

In one embodiment, the phenolic/epoxy binder component of the present invention is incorporated into a paste, such as, a resistor paste. An additive with at least some degree of electrical conductivity may be added to the phenolic/epoxy component (or a precursor thereto) and incorporated into a ‘paste’. Such additives include but are not limited to carbon (e.g., graphite), metal and oxides, where useful oxides include oxides of one or more elements selected from a group consisting of Si, Al, Ru, Pt, Ir, Sr, La, Nd, Ca, Cu, Bi, Gd, Mo, Nb, Cr and Ti.

In one embodiment of the present invention, an organic solvent is used to minimize water sorption and improve blending or interdispersion properties. Organic solvents found to be useful in the practice of the present invention include any liquid capable of suspending or dissolving at least a portion of the phenolic component, the epoxy component or both components. Useful solvents include those having a normal boiling point above 210, 220, 230, 240, 250 or 260° C. and optionally, between (and optionally between and including) any two of the following temperatures 210, 220, 230, 240, 250 and 260° C.

In one embodiment of the present invention, the phenolic component, the epoxy component, and optionally an additive with at least some degree of electrical conductivity can be combined (with an appropriate organic solvent) to form a paste. As used herein, a “paste” is intended to include solutions, suspensions or otherwise a homogeneous or non-homogeneous material of at least: i. the solvated phenolic/epoxy binder component; or ii. the solvated phenolic/epoxy binder component together with an additive with at least some degree of electrical conductivity. Additional additives may also be used, depending upon the particular application or embodiment of the present invention.

In an aspect of the present invention, the hydrophobic dicyclopentadiene phenolic polymer may be cured with the hydrophobic epoxy at temperatures less than 200, 195, 190, 185, 180, 175, 170, 165, 160, 155 or 150° C. The curing may be on a rigid substrate, such as FR-4 or BT substrates, for example. FR-4 is an industry designation derived from ‘flame retardant 4’, a widely used insulating material for making printed circuit boards constructed of woven glass fibers (fiberglass) and epoxy. BT resin is an industry designation for a heat resistant thermosetting resin typically involving addition polymerization of two main components B (Bismaleimide) and T (Triazine Resin). The curing may be on a flexible substrate, such as, polyester or polyimide film.

Any one of a number of fillers may be added to the phenol/epoxy binders, pastes or other embodiments of the present invention, including (but not limited to): aluminum oxide, titanium oxide, talc (magnesium silicate hydroxide), silicon oxide, silicon carbide, silicon nitride, and the like.

The binder compositions of the present invention can be incorporated into any one of a number of compositions for use in electronic circuitry type applications, including used as a component of a resistive material, as a discrete or planar capacitor, as an inductor, as a circuitry encapsulant, as a conductive adhesives, as a dielectric film or coating, and as an electrical and/or thermal conductor.

One type of electronic component that can be advantageously manufactured using the phenol/epoxy binder of the present invention is a polymer thick film (PTF) resistor, which involve resistors typically formed using screen-printable liquids or pastes. The PTF resistor pastes of the present invention can be applied on a suitable substrate using screen-printing (including stencil printing) or any other similar-type technique. The printed pastes can be cured at relatively low temperatures, e.g., less than 200, 175, 150, 125, 100, or 80 degrees Centigrade. The paste will tend to shrink and compress the conductive particles together, often resulting in increased electrical conductivity between the particles after curing. The electrical resistance of the system tends to depend on the resistance of the materials incorporated into the polymer binder, their particle sizes and loading, as well as the nature of the polymer binder itself. The electrical resistance of PTF resistors formed in this fashion can depend on the degree of contact, if any, between the electrically conductive particles. Ideally, the PTF resistors of the present invention exhibit physical stability (of the cured polymer binder) when exposed to high temperatures and high moisture environments with little if any undue change in the electrical resistance of the resistor.

An embodiment of the present invention relates to methods of forming a resistor. In an aspect of this embodiment, a resistor paste comprising a polymer binder described herein is provided. The polymer binder may include a catalyst. The polymer binder is applied to a substrate having a metal termination, then dried and cured. The metal termination may be non metal-plated copper, as described herein. Metal terminations known to one of skill in the art, including but not limited to metals such as copper, aluminum, nickel, steel or an alloy containing one or more of these metals, are useful in the present invention. The metal may be treated. For example, treated copper, such as micro-etching, black oxide treated and brown oxide treated, are useful in the methods of the present invention.

PTF resistor stability can be measured by several known test measurements, including exposing the resistor to environments at 85° C. and 85% relative humidity to show accelerated aging. Highly Accelerated Stress Test (HAST) is another test measurement where the resistor is exposed to 100% humidity, 2 atm, and 120° C. to show accelerated aging. The PTF resistors of the present invention exhibit advantageously small, if any, change in resistance upon exposure to environmental conditions or test conditions. In many embodiments of the present invention, useful resistance properties can be defined according any one of the following:
1. a brown oxide treatment, such as, Bond Film (Bond Film is a trade name of Atotech Deutschland, GmbH), indicating a resistance change of less than 3%;
2. an 85/85 (24 hour) test indicating a resistance change of less than 5%;
3. a HAST (24 hour, 2 atm) test indicating a resistance change of less than 20%; or
4. a lamination test, indicating a resistance change of less than 8%.
   For compositions of the present invention, the amount of binder (epoxy resin and phenolic resin) can be 40, 50, 60, 70, 75, 80, 85, 90, 95, 96, 97, 98 or 99 weight percent of the final composition (based upon solids content). In one embodiment of the present invention, the polymer binder may contain hydrophobic phenolic resin, and a reactive resin other than epoxy resin. In another embodiment of the present invention, the polymer binder may contain epoxy resin, and no phenolic resin. The epoxy resin may contain a dicyclopentadiene moiety. The phenolic resin may contain a dicyclopentadiene moiety.

In an embodiment of the present invention, the polymer binder may contain catalysts, cross-linkers, and/or fillers. The amount of the catalysts, cross-linkers, and/or fillers may vary dependent upon the particular phenolic resin, the particular epoxy resin, or the ratio of epoxy resin to phenolic resin. One of skill in the art will vary these components to achieve the desired properties. One of skill in the art may test the properties of the polymer binder, paste, resistor paste, and/or resistor according to methods and tests described herein.

In a non-limiting embodiment of the present invention, the resistor films of the present invention may provide a sufficiently stable and reliable interface when bonded directly to a copper trace, simply referred to herein as “non metal-plated copper” (e.g., no silver immersion plating process applied to the copper prior to resistor film application). The omission of the silver-plating process will tend to lower overall cost and complexity in the use of the present invention. The term “pure copper” as referred to herein, is intended to mean a copper surface devoid of a silver plating process or any other metal based adhesive primer that would otherwise be applied to the copper surface prior to bonding the copper surface to the resistor thick film of the present invention.

Optionally, the present invention can also comprise certain epoxies and phenolics containing dicyclopentadiene moiety.

In the practice of the present invention an organic solvent may be selected that can easily dissolve the phenolic and epoxy component and which can be removed (later in processing) at a relatively low operating temperature. In one embodiment of the present invention an electrically conductive material can be added to the phenolic/epoxy component to make these compositions useful as an electronic-grade paste. Generally, these electrically conductive materials can be in the form of a powder. Commonly used powders can be metals or metal oxides. Other common powders include common graphite materials and carbon powders. In another embodiment of the present invention, the electrically conductive material can be a reduced oxide of a metal selected from the group consisting of Ru, Bi, Gd, Mo, Nb, Cr and Ti. The term “metal oxide” can be defined herein as a mixture of one or more metals with an element of Groups IIIA, IVA, VA, VIA or VIIA of the Periodic Table. In particular, the term metal oxides can include metal carbides, metal nitrides, and metal borides, titanium nitride and carbide, zirconium boride and carbide and tungsten boride.

In general, the amount of electrically conductive material added to a composition depends on the end use application (e.g., either the electrical conductivity or resistivity desired). In general, one amount of electrically conductive material found to be useful can range between, and including, any two of the following numbers, 10, 15, 20, 25, 30, 35, 40, 45, 50, 55, 60, 65, 70, 75 and 80 weight percent of the total dry weight of the composition. Typically ruthenium oxides, or complex metals having ruthenium in them, can be used to prepare compositions having a lower electrical resistivity. In ‘higher range’ electrical resistivity applications, titanium nitride and carbide, zirconium boride and carbide, and tungsten boride, can be used.

Paste compositions containing the phenolics and epoxies of the invention can be used in multiple electronic applications. In one embodiment, the liquid and paste compositions of the invention will include a phenolic with a glass transition temperature greater than 220° C.; in a further embodiment, greater than 230° C. In one embodiment, the compositions will also comprise a phenolic with a water absorption factor of 2% or less; in a further embodiment, 1.5% or less; and in a further embodiment 1% or less.

Most thick film compositions are applied to a substrate by screen printing, stencil printing, dispensing, doctor-blading into photoimaged or otherwise preformed patterns, or other techniques known to those skilled in the art. These compositions can also be formed by any of the other techniques used in the composites industry including pressing, lamination, extrusion, molding, and the like. However, most thick film compositions are applied to a substrate by means of screen-printing. Therefore, they must have appropriate viscosity so that they can be passed through the screen readily. In addition, they should be pseuodoplastic in order that they set up rapidly after being screened, thereby giving good resolution. Although the rheological properties are of importance, the organic solvent should also provide appropriate wettability of the solids and the substrate, a good drying rate, and film strength sufficient to withstand rough handling.

Curing of a final paste composition is accomplished by any number of standard curing methods including convection heating, forced air convection heating, vapor phase condensation heating, conduction heating, infrared heating, induction heating, or other techniques known to those skilled in the art. In one embodiment of the present invention, a catalyst can be used to aid in curing of a polymer matrix and improving shelf life. Useful catalysts of the present invention include, but are not limited to, blocked or unblocked tertiary aromatic amine catalysts. Examples of these catalysts include dimethylbenzylammonium acetate and dimethylbenzylamine.

In one embodiment of the present invention, the phenolic/epoxy component can be combined with other functional fillers to form different types of electronic materials. For example, functional fillers for capacitors include, but are not limited to, barium titanate, barium strontium titanate, lead magnesium niobate, and titanium oxide. Functional fillers for encapsulants include, but are not limited to, talc, fumed silica, silica, fumed aluminum oxide, aluminum oxide, bentonite, calcium carbonate, iron oxide, titanium dioxide, mica and glass. Encapsulant compositions can be unfilled, with only the organic binder system used, which has the advantage of providing transparent coatings for better inspection of the encapsulated component. Functional fillers for thermally conductive coatings include, but are not limited to barium nitride, aluminum nitride, aluminum oxide coated aluminum nitride, silicon carbide, boron nitride, aluminum oxide, graphite, beryllium oxide, silver, copper, and diamond.

PTF materials have received wide acceptance in commercial products, notably for flexible membrane switches, touch keyboards, automotive parts and telecommunications. In one embodiment of the present invention, a resistor (or resistive element) is prepared by printing a PTF composition, or ink, onto a sheet in a pattern. The resistor paste cured on a substrate may be useful in Printed Wiring Board (PWB) fabrication. Here, it can be important to have uniform resistance across the sheet (i.e., the resistance of elements on one side of the sheet should be the same as that of elements on the opposite side). Variability in the resistance can significantly reduce yield. The resistive element should be both compositionally and functionally stable. Obviously, one of the most important properties for a resistor is the stability of the resistor over time and under certain environmental stresses. The degree to which the resistance of the PTF resistor changes over time or over the lifetime of the electronic device can be critical to performance. Also, because PTF resistors are subject to lamination of inner layers in a printed circuit board, and to multiple solder exposures, thermal stability is needed. Although some change in resistance can be tolerated, generally the resistance changes need to be less than 5%.

An embodiment of the present invention relates to circuit boards including the resistor pastes described herein. The circuit board may be a high-density circuit board. Devices, such as handheld devices, which include the described high-density circuit boards, are hereby contemplated.

Resistance can change because of a change in the spacing or change in volume of functional fillers, i.e., the resistor materials in the cured PTF resistor. To minimize the degree of volume change, the phenolic component and the epoxy component (i.e., the phenolic/epoxy component) should have low water absorption so the cured phenolic based material does not swell when exposed to moisture. Otherwise, the spacing of the resistor particles will change resulting in a change in resistance.

Resistors also need to have little resistance change with temperature in the range of temperatures the electronic device is likely to be subjected. The thermal coefficient of resistance must be low, generally less than 200 ppm/° C.

The compositions of the present invention can be especially suitable for providing polymer thick film (PTF) resistors. The PTF resistors made from the inventive phenolics and corresponding compositions exhibit exceptional resistor properties and are thermally stable even in relatively high moisture environments.

In one embodiment of the present invention, the compositions can also be dissolved into a solution and used in integrated circuit chip-scale packaging and wafer-level packaging. These compositions can be used as semiconductor stress buffer, interconnect dielectric, protective overcoat (e.g., scratch protection, passivation, etch mask, etc.), bond pad redistribution, an alignment layer for a liquid crystal display, and solder bump under fills.

The advantages of the materials present invention are illustrated in the following EXAMPLES. Processing and test procedures used in preparation of, and testing, of the phenolics of the present invention (and compositions containing these phenolics) are described below.

### 3 Roll Milling

A three-roll mill may be used for grinding pastes to fineness of grind (FOG) generally <5μ. The gap may be adjusted to 1 mil before beginning. Pastes are typically roll-milled for three passes at 0, 50, 100, 150, 200, 250 psi until FOG is <5μ. Fineness of grind is a measurement of paste particle size. A small sample of the paste is placed at the top (25μ mark) of the grind gauge. Paste is pushed down the length of the grind gauge with a metal squeegee. FOG is reported as x/y, where x is the particle size (microns) where four or more continuous streaks begin on the grind gauge, and y is the average particle size (micron) of the paste.

### Screen-Printing

A 230 or 280 mesh screen and a 70-durometer squeegee may be used for screen-printing. Printer may be set up so that snap-off distance between screen and the surface of the substrate is typically 35 mils for an 8 in×10 in screen. The downstop (mechanical limit to squeegee travel up and down) may be preset to 5 mil. Squeegee speed used may be 1 in/second, and a print-print mode (two swipes of the squeegee, one forward and one backward) may be used. A minimum of 20 specimens (per paste) may be printed. In an embodiment, after all the substrates for a paste are printed, they are left undisturbed for a minimum of 10 minutes (so that air bubbles can dissipate), then cured 1 hr at 170° C. in a forced draft oven.

### 85° C./85% RH Testing

A minimum of three specimens that have not been cover coated are placed in an 85° C./85% RH chamber and aged for 125, 250, 375 and 500 hr at 85/85. After exposure time is reached, samples are removed from the chamber, oxidation is removed from the copper leads with a wire brush and the resistance promptly determined.

### HAST Testing

A minimum of three specimens that have not been cover coated are placed in an 120° C./100% RH/2 atm chamber and aged for 24 hours. After exposure time is reached, samples are removed from the chamber, oxidation is removed from the copper leads with a wire brush and the resistance promptly determined.

### TCR

TCR (thermal coefficient of resistance) is measured and reported in ppm/° C. for both hot TCR (HTCR) at 125° C. and cold TCR (CTCR) at −40° C. A minimum of 3 specimens for each sample, each containing 8 resistors, is used. The automated TCR averages the results.

### Thermal Conductivity Measurement

A film ˜0.3 mm is prepared on releasing paper by solution cast, followed by drying at 170° C. for 1 hour. A 1″ diameter puncher is used to cut the sample into the right size. For the thermal conductivity determination a laser flash method is used to determine the thermal conductivity. Samples are sputtered with ˜200 Å of Au layer in order to block the laser flash being seen by the IR detector during the measurement. The gold coating is then sprayed with three coats of micronically fine synthetic graphite dispersion in Fluoron®. The graphite coating increases the absorption of radiation on the laser side of the sample, and increases the emission of radiation on the detector side.

The specific heat is determined first by comparing with that of a standard (Pyrex® b 7740), and then corrected by subtracting those of gold and graphite coatings. The bulk density is calculated based on the formulation. Thermal diffusivity in the unit of cm/s is obtained via a Netzsh laser flash instrument. The thermal conductivity is calculated as:

Conductivity=(Diffusivity×Density×Specific Heat)

Temperature is controlled at 25° C. via a Neslab circulating batch. Scan time is set at 200 ms with an amperage gain of 660 for Pyrex® standard and 130-200 second and 600 gain for the sample. A Nd:glass laser of 1060 nm and pulse energy of 15 J and pulse width of 0.33 ms is used. Three laser shots are taken for each sample.

### Example 1

EXAMPLE 1 illustrates the use of a high T_{g}, crosslinkable, low moisture absorption, dicyclopentadiene phenolic resin used in a PTF resistor paste composition.

To a dry three neck round bottom flask equipped with nitrogen inlet, mechanical stirrer and condenser was added 50 grams of Butyl Carbitol and 50 grams dry chunks of the phenolic, D_SD_{—}1819. The solution was heated to 150° C. and was stirred for 2 hrs till all chunks were fully dissolved.

2.5 grams of hexamethylenetetramine, the catalyst, was added to the solution with continuous stirring and heating at 100° C. for another 2 hours until hexamethylenetetramine was fully dissolved. The solution was cooled to room temperature and its solid content was determined by measuring the weight loss of 10 g of solution after heating at 170° C. for 3 hours.

The PTF resistor paste included one or more metal powders (or metal oxides), phenolic resin and catalyst solution, and a zirconate dispersant, zirconium (IV), b is 2,3(bis-2-propenolatomethyl)butanolato, bis-(para-aminobenzoato-O). The PTF resistor paste composition was prepared by mixing the following ingredients in an ambient environment with stirring to give a crude paste mixture. The final paste composition yielded a 71.8 percent by weight solids paste mixture. PTF resistor paste was prepared by adding to the phenolic and catalyst solution the ingredients listed below.

| Ingredient | % by weight |
|---|---|
| Ruthenium dioxide powder | 15.9 |
| Bismuth ruthenate powder | 3.2 |
| Silver powder | 19.1 |
| Graphite | 19.1 |
| Phenolic and catalyst solution (51.2%) | 28.0 |
| Butyl carbitol | 14.3 |
| Zirconate dispersant solution (46%) | 0.4 |

This PTF resistor paste was 3-roll milled with a 1 mil gap with 3 passes each set at 0, 50, 100, 200, 250 and 300 psi pressure to yield a fineness of grind of 4/2.

The PTF resistor paste was printed directly onto chemically cleaned copper without a silver immersion process. The paste was screen-printed using a 280-mesh screen, a 70-durometer squeegee, on print-print mode, at 10-psi squeegee pressure, on chemically cleaned FR-4 substrates, and with a 40 and 60 mil resistor pattern. The samples were baked in a forced draft oven at 170° C. for 1 hr.

The samples were treated with a Bond Film (from Atotech) to form copper oxide coating to ensure good adhesion with epoxy pre-preg after thermal lamination. Cured resistor coupons were first cleaned with 10% of sulfuric acid at room temperature for 20 seconds, followed by rinsing with deionized water at room temperature for 20 seconds. Coupons were then treated with a solution of 3-4% of sodium hydroxide and 5-10% of amine at 55° C. for 20 seconds, followed by rinsing with deionized water at room temperature for 20 seconds. Copper oxide was formed by two sequential process of emerging coupons in Predip (from Atotech) at 40° C. for 12 seconds and in Bond Film solution (from Atotech) at 35° C. for 50 seconds. Finally, coupons were rinsed with de-ionized water at room temperature for 30 seconds and dry at 80° C. for 15 minutes. Resistance difference was measured before and after Bond Film process.

The samples were then laminated with epoxy pre-preg at alleviated temperature and pressure. The samples were held at the peak temperature at 200° C. at the peak pressure of 550 psi for 75 minutes.

The properties of the resulting PTF resistor were measured as described herein, and recorded as follows:

| | |
|---|---|
| Resistance (ohm/square) | 31 |
| Thickness (microns) | 30 |
| HTCR (ppm/° C.) | 297 |
| CTCR (ppm/° C.) | −170 |
| % resistance change | |
| after Bond Film: | 1.8 |
| after pre-preg lamination: | −11.6 |
| HAST 24 hours | 18.8 |
| 85/85, 96 hours | 1.5 |

### Example 2

EXAMPLE 2 illustrates the use of a high T_{g} crosslinkable epoxy crosslinked with a low moisture absorption dicyclopentadiene phenolic resin used in a PTF resistor paste composition.

To a dry three neck round bottom flask equipped with nitrogen inlet, mechanical stirrer and condenser was added 50 grams of Butyl Carbitol and 50 grams dry chunks of D_SD_{—}1819. The solution was heated to 150° C. and was stirred for 2 hrs till all chunks were fully dissolved. The solution was cooled to room temperature and its solid content was determined by measuring the weight loss of 10 g of solution after it was heated at 170° C. for 3 hours.

To a dry three neck round bottom flask equipped with nitrogen inlet, mechanical stirrer and condenser was added 40 grams of Butyl Carbitol and 60 grams dry chunks of Su-8. The solution was heated to 100° C. and was stirred for 2 hrs till all chunks were fully dissolved. The solution was cooled to room temperature and its solid content was determined by measuring the weight loss of 10 g of solution after it was heated at 170° C. for 3 hours.

The PTF resistor paste included one or more metal powders (or metal oxides), epoxy resins, phenolic resins, and a catalyst, benzyldimethyl ammonium acetate. A PTF resistor paste was prepared using the method described in Example 1 by adding to the epoxy and phenolic solution the ingredients listed below.

| Ingredient | % by weight |
|---|---|
| Ruthenium dioxide powder | 16.6 |
| Bismuth ruthenate powder | 3.3 |
| Silver powder | 19.9 |
| Graphite powder | 16.6 |
| 60% Epoxy(Su-8) solution | 7.8 |
| 52.79% Phenolic (D_SD_1819) solution | 15.5 |
| Benzyldimethyl ammonium acetate | 0.5 |
| Butyl Carbitol | 19.7 |

The final paste composition yielded a 69.8 percent by weight solids paste mixture. The resistor samples were prepared as described in Example 1.

The properties of the resulting PTF resistor were measured as described herein, and recorded as follows:

| | |
|---|---|
| Resistance (ohm/square) | 80 |
| Thickness (microns) | 30 |
| HTCR (ppm/° C.) | 420 |
| CTCR (ppm/° C.) | 51 |
| % resistance change | |
| after Bond Film: | 0.26 |
| after pre-preg lamination: | −6.5 |
| HAST 24 hours | 15.3 |
| 85/85, 96 hours | 1.0 |

### Example 3

EXAMPLE 3 illustrates the use of a low moisture absorption dicyclopentadiene epoxy resin crosslinked with a low moisture absorption dicyclopentadiene phenolic resin as the polymeric resistor binder used in a PTF resistor paste composition similar to EXAMPLE 1 and 2.

To a dry three neck round bottom flask equipped with nitrogen inlet, mechanical stirrer and condenser was added 60 grams of Butyl Carbitol and 40 grams dry chunks of XD-1000. The solution was heated to 100° C. and was stirred for 2 hrs till all chunks were fully dissolved. The solution was cooled to room temperature and its solid content was determined by measuring the weight loss of 10 g of solution after it was heated at 170° C. for 3 hours.

The phenolic solution was prepared using the method described in Example 2.

A PTF resistor paste was prepared using the method described in Example 1 and 2 by adding to the epoxy and phenolic solution the ingredients listed below.

| Ingredient | % by weight |
|---|---|
| Ruthenium dioxide powder | 13.2 |
| Bismuth ruthenate powder | 2.6 |
| Silver powder | 15.9 |
| Graphite powder | 15.9 |
| 60% Epoxy(XD-1000) solution | 14.6 |
| 57.8% Phenolic (D_SD_1819) solution | 23.8 |
| Benzyldimethyl ammonium acetate | 0.7 |
| Butyl Carbitol | 13.2 |

The final paste composition yielded a 70.9 percent by weight solids paste mixture. The resistor samples were prepared as described in Example 1 and 2.

The properties of the resulting PTF resistor were measured as described herein, and recorded as follows:

| | |
|---|---|
| Resistance (ohm/square) | 169 |
| Thickness (microns) | 16.4 |
| HTCR (ppm/° C.) | 204 |
| CTCR (ppm/° C.) | −186 |
| % resistance change | |
| after Bond Film: | −2.4 |
| after pre-preg lamination: | −5.6 |
| HAST 24 hours | −6.2 |

### Example 4

EXAMPLE 4 illustrates the use of a low moisture absorption dicyclopentadiene epoxy resin crosslinked with a low moisture absorption dicyclopentadiene phenolic resin as the polymeric resistor binder used in a PTF resistor paste composition similar to EXAMPLE 3.

The phenolic solution (D_SD-1819) was prepared using the method described in Example 2.

The epoxy (XD-1000) solution was prepared using the method described in Example 3.

A PTF resistor paste was prepared using the method described in Example 1, 2, and 3 by adding to the epoxy and phenolic solution the ingredients listed below.

| Ingredient | % by weight |
|---|---|
| Ruthenium dioxide powder | 13.2 |
| Bismuth ruthenate powder | 2.6 |
| Silver powder | 15.9 |
| Graphite powder | 15.9 |
| 60% Epoxy (XD-1000) solution | 7.9 |
| 57.8% Phenolic (D_SD_1819) solution | 30.4 |
| Benzyldimethyl ammonium acetate | 0.9 |
| Butyl Carbitol | 13.2 |

The final paste composition yielded a 64.4 percent by weight solids paste mixture. The resistor samples were prepared as described in Example 1, 2, and 3.

The difference in composition between Example 3 and Example 4 is the ratio of Phenolic (D_SD_{—}1819) over Epoxy (XD-1000). The binder used in Example 3 exhibited better crosslinking. As a result, the resistance change after pre-preg lamination of Example 3 is much lower than that of Example 4.

The properties of the resulting PTF resistor were recorded as follows:

| | |
|---|---|
| Resistance (ohm/square) | 94 |
| Thickness (microns) | 20.3 |
| HTCR (ppm/° C.) | 226 |
| CTCR (ppm/° C.) | −205 |
| % resistance change | |
| after Bond Film: | 1.2 |
| after pre-preg lamination: | −46.8 |
| HAST 24 hours | −7.5 |

### Example 5

EXAMPLE 2 illustrates the use of a high T_{g} crosslinkable epoxy crosslinked with phenolic novolac resin used in a PTF resistor paste composition.

To a dry three neck round bottom flask equipped with nitrogen inlet, mechanical stirrer and condenser was added 50 grams of Butyl Carbitol and 50 grams dry chunks of GP 5833. The solution was heated to 80° C. and was stirred for 2 hrs till all chunks were fully dissolved. The solution was cooled to room temperature and its solid content was determined by measuring the weight loss of 10 g of solution after it was heated at 170° C. for 3 hours.

To a 20 ml vial included with a magnetic stirrer, 15 grams of N,N-dimethylformamide (DMF) and 5 grams of dicyandiamide. The solution was stirred at room temperature or 8 hrs till all powder was fully dissolved.

The PTF resistor paste included one or more metal powders (or metal oxides), epoxy resins, phenolic resins, and the crosslinker, dicyandiamide. A PTF resistor paste was prepared using the method described in Example 1, 2, 3, and 4 by adding to the epoxy and phenolic solution the ingredients listed below.

| Ingredient | % by weight |
|---|---|
| Ruthenium dioxide powder | 33.8 |
| Bismuth ruthenate powder | 27.1 |
| Alumina powder | 6.8 |
| Graphite powder | 2.0 |
| Phenolics (50% GP5833 in butyl carbitol) | 13.5 |
| Epoxy powder (RSS-1407) | 5.0 |
| 25% dicyandiamide in DMF | 5.1 |
| Butyl Carbitol | 6.8 |

The final paste composition yielded a 55.2 percent by weight solids paste mixture. The resistor samples were prepared as described in Example 1.

As shown in the below results, using a conventional epoxy-phenolic novolac binder system failed to achieve good reliability (85/85) for resistor compositions.

The properties of the resulting PTF resistor were recorded as follows:

| | |
|---|---|
| Resistance (ohm/square) | 41.4 |
| Thickness (microns) | 15 |
| % resistance change | |
| after Bond Film: | −1.9 |
| after pre-preg lamination: | −13.1 |
| 85/85, 120 hours | 17.3 |

### Example 6

This example illustrates the creation of a medium prepared by dissolving SU-8, a hydrophobic epoxy resin manufactured by Hexion, formerly Resolution Performance Products, in butyl carbitol. A 1 liter resin kettle was fitted with a mechanical stirrer, addition port, heating mantle, and nitrogen purge. After assembly, 300 g of butyl carbitol was added to the kettle. The solvent was then heated to approximately 80° C. with stirring. After this temperature was reached, 200 g powdered SU-8 was added slowly through the addition port. Addition took place over period of approximately 30 minutes. After SU-8 addition, the slurry was allowed to stir for 2 hours during which time the SU-8 softened and dissolved in the butyl carbitol. After two hours, heating was discontinued, the solution was discharged into a suitable container. Solids were determined by removing three-gram samples, placing them in aluminum pans, weighing each sample before and after heating at 150° C. for four hours. The average solids content was 40.2% relative to a theoretical value of 40%.

### Example 7

This example illustrates the preparation of a polymer thick film resistor from SU-8 and tetramethylbisphenol-A, a phenolic with alkyl substituents that impart added hydrophobic character through increased organic content, and so-called hydrophobic shielding.

The PTF resistor paste included one or more metal powders (or metal oxides), and an amine catalyst. The PTF resistor paste composition was prepared by mixing the following ingredients in an ambient environment with stirring to give a crude paste mixture.

| Ingredient | Amount (g) |
|---|---|
| Ruthenium dioxide powder | 28 |
| Bismuth ruthenate powder | 16 |
| Graphite | 1.5 |
| Alumina powder | 10 |
| SU-8 solution from Example 6 | 17 |
| Tetramethylbisphenol A | 3.5 |
| 2-ethyl-4-methyl benzimidazole | 0.2 |
| butyl carbitol | 5.0 |

The PTF resistor paste was 3-roll milled with a 1 mil gap with 3 passes each set at 0, 50, 100, 200, 250 and 300 psi pressure to yield a fineness of grind of 5 over 2. The paste was screen-printed using a 200-mesh screen, a 80-durometer squeegee, on print-print mode, at 10-psi squeegee pressure, on chemically cleaned FR-4 substrates, and with a 40 and 60 mil resistor pattern.

The PTF resistor paste was printed directly onto chemically cleaned copper (microetched copper) without a silver immersion process. Silver immersion processes are typically used to pre-treat a copper surface in polymer thick film resistor applications.

The printed resistors were baked in a forced air convection oven at 170° C. for 1 hr followed by 2 min at 230° C. cure in air. The coupons were then laminated with epoxy pre-preg at elevated temperature and pressure. The samples were held at the peak temperature at 200° C. at the peak pressure of 550 psi for 75 minutes.

The properties of the resulting cured PTF resistor were recorded as follows:

| | |
|---|---|
| Resistance (ohm/square) | 125 |
| Thickness (microns) | 20 |
| % resistance change of 40 mil resistors after: | |
| Lamination | −5.5 |
| 500 hrs at 85° C./85% RH | 3.8 |
| Thermal cycling (−25° C. to 125° C., 50 cycles) | −1.8 |
| Electrostatic dissipation (5 by 2000 V pulses) | −0.2% |
| HTCR (25 to 125° C.) | 971 ppm/° C. |
| CTCR (−55 to 125° C.) | 374 ppm/° C. |

### Example 8

This example illustrates the preparation of a polymer thick film resistor from SU-8 and tetrabromobisphenol-A, a halogenated phenolic that imparts added hydrophobic character.

The PTF resistor paste included one or more metal powders (or metal oxides), and an amine catalyst. The PTF resistor paste composition was prepared by mixing the following ingredients in an ambient environment with stirring to give a crude paste mixture.

| Ingredient | Amount (g) |
|---|---|
| Ruthenium dioxide powder | 35 |
| Bismuth ruthenate powder | 20 |
| Graphite | 1.9 |
| Alumina powder | 12 |
| SU-8 solution from Example 6 | 17 |
| Tetrabromobisphenol-A | 5.9 |
| 2-ethyl-4-methyl benzimidazole | 0.2 |
| butyl carbitol | 7.0 |

The PTF resistor paste was 3-roll milled with a 1 mil gap with 3 passes each set at 0, 50, 100, 200, 250 and 300 psi pressure to yield a fineness of grind of 6 over 3. The paste was screen-printed using a 200-mesh screen, a 80-durometer squeegee, on print-print mode, at 10-psi squeegee pressure, on chemically cleaned FR-4 substrates, and with a 40 and 60 mil resistor pattern.

The PTF resistor paste was printed directly onto chemically cleaned copper (microetched copper) without a silver immersion process. Silver immersion processes are typically used to pre-treat a copper surface in polymer thick film resistor applications.

The printed resistors were baked in a forced air convection oven at 170° C. for 1 hr followed by 2 min at 230° C. cure in air. The coupons were then laminated with epoxy pre-preg at elevated temperature and pressure. The samples were held at the peak temperature at 200° C. at the peak pressure of 550 psi for 75 minutes.

The properties of the resulting cured PTF resistor were recorded as follows:

| | |
|---|---|
| Resistance (ohm/square) | 55 |
| Thickness (microns) | 23 |
| % resistance change of 40 mil resistors after: | |
| Lamination | −0.9 |
| 500 hrs at 85° C./85% RH | 4.6 |
| Thermal cycling (−25° C. to 125° C., 50 cycles) | −1.4 |
| Electrostatic dissipation (5 by 2000 V pulses) | −0.3% |
| HTCR (25 to 125° C.) | 521 ppm/° C. |
| CTCR (−55 to 125° C.) | 136 ppm/° C. |

### Example 9

This example illustrates the preparation of a polymer thick film resistor from SU-8 and hexafluorobisphenol-A, a fluorinated phenolic that imparts added hydrophobic character.

The PTF resistor paste included one or more metal powders (or metal oxides), and an amine catalyst. The PTF resistor paste composition was prepared by mixing the following ingredients in an ambient environment with stirring to give a crude paste mixture.

| Ingredient | Amount (g) |
|---|---|
| Ruthenium dioxide powder | 30 |
| Bismuth ruthenate powder | 17 |
| Graphite | 1.5 |
| Alumina powder | 11 |
| SU-8 solution from Example 6 | 17 |
| Hexafluorobisphenol-A | 4.0 |
| 2-ethyl-4-methyl benzimidazole | 0.2 |
| butyl carbitol | 5.0 |

The PTF resistor paste was 3-roll milled with a 1 mil gap with 3 passes each set at 0, 50, 100, 200, 250 and 300 psi pressure to yield a fineness of grind of 6 over 4. The paste was screen-printed using a 200-mesh screen, a 80-durometer squeegee, on print-print mode, at 10-psi squeegee pressure, on chemically cleaned FR-4 substrates, and with a 40 and 60 mil resistor pattern.

The PTF resistor paste was printed directly onto chemically cleaned copper (microetched copper) without a silver immersion process. Silver immersion processes are typically used to pre-treat a copper surface in polymer thick film resistor applications.

The printed resistors were baked in a forced air convection oven at 170° C. for 1 hr followed by 2 min at 230° C. cure in air. The coupons were then laminated with epoxy pre-preg at elevated temperature and pressure. The samples were held at the peak temperature at 200° C. at the peak pressure of 550 psi for 75 minutes.

The properties of the resulting cured PTF resistor were recorded as follows:

| | |
|---|---|
| Resistance (ohm/square) | 57 |
| Thickness (microns) | 21 |
| % resistance change of 40 mil resistors after: | |
| Lamination | 4.2 |
| 500 hrs at 85° C./85% RH | 2.4 |
| Thermal cycling (−25° C. to 125° C., 50 cycles) | −2.5 |
| Electrostatic dissipation (5 by 2000 V pulses) | −0.2% |
| HTCR (25 to 125° C.) | 499 ppm/° C. |
| CTCR (−55 to 125° C.) | 127 ppm/° C. |

### Example 10

### Comparative Example

This example illustrates the preparation of a polymer thick film resistor from SU-8 and bisphenol-A, a conventional phenolic whose chemical structure does not impart added hydrophobic character. The 85/85 performance is substandard relative to Examples 7-9.

The PTF resistor paste included one or more metal powders (or metal oxides), and an amine catalyst. The PTF resistor paste composition was prepared by mixing the following ingredients in an ambient environment with stirring to give a crude paste mixture.

| Ingredient | Amount (g) |
|---|---|
| Ruthenium dioxide powder | 26 |
| Bismuth ruthenate powder | 15 |
| Graphite | 1.4 |
| Alumina powder | 9.4 |
| SU-8 solution from Example 6 | 17 |
| Bisphenol-A | 2.9 |
| 2-ethyl-4-methyl benzimidazole | 0.2 |
| butyl carbitol | 3.0 |

The PTF resistor paste was 3-roll milled with a 1 mil gap with 3 passes each set at 0, 50, 100, 200, 250 and 300 psi pressure to yield a fineness of grind of 4 over 2. The paste was screen-printed using a 200-mesh screen, a 80-durometer squeegee, on print-print mode, at 10-psi squeegee pressure, on chemically cleaned FR-4 substrates, and with a 40 and 60 mil resistor pattern.

The PTF resistor paste was printed directly onto chemically cleaned copper (microetched copper) without a silver immersion process. Silver immersion processes are typically used to pre-treat a copper surface in polymer thick film resistor applications.

The printed resistors were baked in a forced air convection oven at 170° C. for 1 hr followed by 2 min at 230° C. cure in air. The coupons were then laminated with epoxy pre-preg at elevated temperature and pressure. The samples were held at the peak temperature at 200° C. at the peak pressure of 550 psi for 75 minutes.

The properties of the resulting cured PTF resistor were recorded as follows:

| | |
|---|---|
| Resistance (ohm/square) | 185 |
| Thickness (microns) | 20 |
| % resistance change of 40 mil resistors after: | |
| Lamination | −4.2 |
| 500 hrs at 85° C./85% RH | 20.6 |
| Thermal cycling (−25° C. to 125° C., 50 cycles) | −2.7 |
| Electrostatic dissipation (5 by 2000 V pulses) | −0.2% |
| HTCR (25 to 125° C.) | 978 ppm/° C. |
| CTCR (−55 to 125° C.) | 390 ppm/° C. |

What is claimed is:

1. A method of manufacturing polymeric thick film resistor compositions for electronic circuitry applications, comprising:
a. combining a plurality of filler particles in a binder, said binder comprising a cyclo-aliphatic moiety, a phenolic moiety and an epoxy moiety;
b. contacting the binder composition to a substrate; and
c. curing the binder to:
i. a glass transition temperature (“Tg”) of at least 200 (° C.);
ii. a moisture content of less than 1 weight percent; and
iii. a thermal coefficient of resistance less than 200 ppm/° C.,
to provide a polymeric thick film resistor.

2. A method in accordance with claim 1, wherein the cycloaliphatic moiety comprises dicyclopentadiene;

3. A method in accordance with claim 1, wherein the binder is partially derived from a dihydroxynaphthalene diglycidyl ether, a naphthol-modified cresol novolac, limonene phenol novolac epoxy or a combination thereof.

4. A method in accordance with claim 1, wherein the binder is partially derived from a bisphenol.

5. A method in accordance with claim 1, wherein the binder, prior to curing, has a weigh average molecular weight of less than 100,000.

6. A method in accordance with claim 1, wherein an amine or a blocked amine is used to catalyze the curing of the binder.

7. A method in accordance with claim 1, wherein the filler particles comprise carbon, metal, metal oxide, or combinations thereof, and wherein the amount of filler particles within the resistor thick film is from 10 to 80 weight percent.

8. A method in accordance with claim 1, wherein binder is cured at a temperature of less than 200° C.

9. A method in accordance with claim 1, wherein the substrate comprises FR-4 epoxy, BT epoxy, polyimide, polyester or metal.

10. A method in accordance with claim 1, further comprising: incorporating at least one metal layer onto the polymeric thick film resistor to provide a planar capacitor.

11. A method in accordance with claim 1, further comprising: incorporating at least one metal layer onto the polymeric thick film resistor to provide a planar capacitor.

12. A method in accordance with claim 1, wherein the substrate surface is a pure copper.
